(19) United States
(12) Patent Application Publication
(10) Pub. No.: US 2010/0038424 A1
(43) Pub. Date: Feb. 18, 2010

(54) METHOD AND APPARATUS FOR BULK TESTING OF SMART CARD DEVICES

(75) Inventors: Oded Bashan, Rosh Pina (IL); Aharon Binur, Beit-Hillel (IL); Ronnie Gilboa, Moshav Beit-Hillel-Doar-Na Galil Elyon (IL); Nehemya Itay, Kibbutz Kfar Giladi-Doar-Na Galil Elyon (IL); Moshe Aduk, Korazim (IL)

Correspondence Address: MARTIN D. MOYNIHAN d/b/a PRTSI, INC., P.O. BOX 16446, ARLINGTON, VA, 22215, US

(73) Assignee: On Track Innovations Ltd., Rosh Pina, IL (US)

(21) Appl. No.: 12/522,548

(22) PCT Filed: Jan. 9, 2007
(86) PCT No.: PCT/IL07/00027

§ 371 Date: Jul. 9, 2009

(51) Int. Cl. G06K 7/00

(52) U.S. Cl. 235/439

(57) ABSTRACT

Method and apparatus for simultaneously communicating with multiple smart card devices (17) supported on a common platform (16) so that each device has a respective chip (18) coupled to a respective communication interface (19). The common platform is positioned on a support surface (25) of a multi-head reader (21) so that the respective communication interface of each device is aligned with a respective head (23) of the reader; and multiple heads of the reader are simultaneously energized so as to effect communication with respective devices. The respective chip (18) and device coil antenna (19) of each of the smart card devices (17) may form a respective inlay, multiple inlays being integrally formed on a common inlay sheet constituting the common platform.

### FIELD OF THE INVENTION

This invention relates to testing of smart cards.

### BACKGROUND OF THE INVENTION

Within the technological field of contactless smart card as well as combi-cards having both contact and contactless functionality, the term “inlay” denotes a layer that supports an antenna coil and a chip on board. In use, the chip stores data as well as a program that permits data transfer, typically in both directions, with a card reader when the card is brought into proximity to the reader. All the functionality of the smart card is contained within the inlay: the only difference between the inlay and the final smart card is the lamination and artwork that is applied to opposing surfaces of the inlay. However, before this is done, the inlay is tested to ensure is compliance with the relevant standards. The tests include functionality testing of the antenna and chip. Current approaches to testing inlays require that each inlay be tested separately. Those that pass are conveyed to a subsequent stage of manufacture where the outer lamination and artwork are applied; those that fail are discarded

US 2005/274794 disclose a smart electronic personal identification document, including a smart identification module that includes a contactless chip module and an antenna. The smart identification module is operative to store and exchange personal identification information contactlessly with an external reader. An automated anti-skimming element is configured for preventing unauthorized theft of the information. In an initial test phase, the chip functionality is tested, resulting in the storage (registration) of a chip serial number (CSN) and a chip operating system serial number (OSSN) in a computer database. The database allows a unique logical link to be established between the CSN and the OSSN. In a second test phase, the complete circuit of the smart inlay including the antenna is functionally tested and the results registered in the database.

During manufacture, the antenna coils are commonly formed by copper etching using a subtractive manufacturing process similar to PCB manufacture. Alternatively, the antenna coils may be screen printed or ink-jet printed using conductive inks. In either case, multiple antenna coils are typically formed on a common insulating layer, which is then cut so as to separate the antennas prior to connection to the chip module.

Test tools of the kind described in US 2005/274794 test only the functionality of a single chip. When mass-manufacturing chips on a common inlay, it may be assumed that all chips on the same inlay will have identical functionality. But they may nevertheless be adapted to different end-users. This will be the case, for instance, when the chip is destined to serve as a credit or security card or an electronic passport that must be given a unique identity that will, upon issue to an end-user, be associated with an ID of the end-user. For example, contactless smart cards that are destined to serve as credit cards must store unique data and/or a key that is issued by the credit card company and that must be completely secure. The unique data or key (referred to generally as “data/key”)is generated using a Hardware Security Module (HSM) located in a secured facility of the credit card issuer company and is conveyed during card personalization to the chip in a highly secure manner that precludes any possibility of eavesdropping and thus being able to ascertain the unique data/key by an external party. Indeed, so secure must this be that also the smart card manufacturer must have no way to obtain this information. When the card is subsequently issued to an end-user, the end-user's ID is loaded to a database of the credit card company, so that the credit card company knows the identity of each card and the corresponding authorized owner. It is critical that the unique data/key remains secure, in order to prevent fraudulent copying of a false data/key to a chip either prior or subsequent to the card's issuance to an end-user, since the unique data/key can be verified in the credit card issuer company secured facilities to identify the user ID and thus which bank account, for example to debit against a charge to the identified credit card.

U.S. Pat. No. 6,902,107 (Shay) corresponding to US2003/201317 entitled “Card personalization system and method” discloses a system and method for personalizing cards and other secure identification documents. It is noted therein that for large volume, batch production of cards, institutions often utilize systems that employ multiple processing stations or modules to process multiple cards at the same time to reduce the overall per card processing time. Examples of such systems include the DataCard 9000 series available from DataCard Corporation of Minneapolis, Minn., the system disclosed in U.S. Pat. No. 4,825,054, and the system disclosed in U.S. Pat. No. 5,266,781 and its progeny. Personalization and production operations that are typically performed on the cards include the programming of data onto a magnetic stripe of the card, monochromatic and/or color printing, programming an integrated circuit chip in the card, embossing, and applying various topcoat and protective layers. A controller is typically employed to transfer data information and instructions for operating the input, the personalization/production stations, and the output.

The card personalization system includes an input at one end of the system that holds a supply of cards and inputs the cards for personalization by the system. The input delivers each of the cards to a plurality of card processing modules arranged in sequence, where one module is downstream from a previous module. An output is disposed at an end of the card personalization system, and collects cards that have been personalized by the card processing modules. In use, a card is picked from an input hopper and transferred to a processing module which begins personalization of the card. Upon completion, the personalized card is fed to an output hopper. It thus emerges that each card is personalized one at a time and the throughput of such a system is therefore limited.

U.S. Pat. No. 6,283,368 (Ormerod) discloses a high speed customizing machine which has a device for transferring portable objects and incorporates an integrated circuit having at least one memory, and a rotary surface equipped with a plurality of hybrid connection devices, positioned transversely to the transfer device and each linked to an electronic card enabling customization of each chip card and positioned in front of each connection device. Such a machine may be used with smart cards having contact or contactless interfaces, as well as with hybrid or so-called combi-cards having both contact and contactless interfaces. To this end, each electronic card may have an interface circuit with an antenna linked by a bus to a microprocessor which executes a customizing program, the bus also allowing the microprocessor to access the contact connection device of an associated hybrid connection device.

The rotary surface includes multiple connection devices each linked to an electronic customization card which manages customization of a chip card inserted by transfer belt into a respective hybrid connection device to which the customization card is linked. Each of the customization cards is networked to a computer dedicated to customization and including software for management of card customization.

In use, after initial testing, cards are conveyed on a transfer belt and picked up by the customization head that is closest to the transfer belt. The rotary drum then rotates while the conveyor belt advances so that the next card is picked up by the next customization head until all customization heads are filled. When this happens, a plurality of smart cards are coupled to respective customization cards that receive commands from the computer and customize the respective chips in each of the smart cards according to the customization data in the respective customization cards.

The customization program recognizes the type of cards and in its algorithm has the instructions necessary for addressing via bus respective connector which corresponds to the type of contact card or contactless card. In the case of hybrid cards, the customization program provides access to the card by a contact interface for customization of certain “non-security” parts and accesses the card via a connector coupled to the antenna for transmitting security information by the contactless interface. Thus the customization program includes means for selectively addressing and selectively controlling the addressing of information on one or more of the connectors.

The system described in U.S. Pat. No. 6,283,368 operates on cards that are fully manufactured. Moreover, before customization, the cards are first tested so as to avoid subsequent customization of faulty cards. The testing is done by a test station into which cards are distributed one at a time by an unstacking device. So although U.S. Pat. No. 6,283,368 allows for simultaneous customization of multiple smart cards, it is to be noted that during the initial testing phase each card is tested one at a time and this introduces a bottleneck into the complete process, even though the testing phase is fast compared with the customization phase. Moreover, since any cards that fail the test are discarded, this results in the final manufacturing stages having been performed in vain. This is wasteful of resources, time and money.

In this connection, it is to be noted that smart card manufacture involves a number of separate operations after fabrication of the chip, assembly on the smart card substrate and connection to the contact pad and/or antenna coil. As noted above, multiple antenna coils may be printed using conductive inks on a common insulating layer, which is then cut so as to separate the antennas prior to connection to the chip module. In accordance with one known approach used by the present applicant, contactless smart cards are produced by layering multiple inlays each supporting an antenna coil and a chip on an inlay sheet. Conventionally, the inlay sheet is then cut in order to separate the constituent inlays, which are mounted between thin PVC sheets to form an ISO standard card.

When chip cards are manufactured individually, it is relatively straightforward to stamp each card with a unique manufacturer's ID, and it is clear from the above discussion that the art addresses this need. It is also known, when mass-producing multiple smart card inlays on a common inlay sheet, to stamp each card with a unique ID and to register the ID of each card together with its x, y coordinates on the inlay sheet. But no suggestion has been made in the art to use this information to add secure data during manufacture substantially simultaneously, let alone to do so in a completely secure manner that preserves confidentiality.

Contactless smart cards operate when brought into proximity with an interrogation field. Different contactless smart card communications standards are known having different ranges of sensitivity. For example, contactless cards complying with ISO/IEC 14443 are known as proximity cards and have a range of up to 10 cm, while cards complying with ISO/IEC 15693 are known as vicinity cards and have a range of up to 1 meter. Clearly, if inlays conforming to either standard are mass-produced on a common backing sheet, it is desirable to place them as close to each other as possible in the interest of increasing packing density and thus reduce waste and manufacturing costs. But close packing of contactless smart card inlays with the resultant small inter-inlay spacing will result in adjacent inlays being susceptible to mutual interference when interrogated by a reader antenna. In order to permit discrete testing and addressing of individual smart card chips, this must be avoided.

### SUMMARY OF THE INVENTION

In one aspect, the present invention provides a method for simultaneously communicating with multiple smart card devices supported on a common platform so that each device has a respective chip coupled to a respective communication interface, said method comprising:

positioning said platform on a support surface of a multi-head reader so that the respective communication interface of each device is aligned with a respective head of the reader; and

simultaneously energizing multiple heads of the reader so as to effect communication with respective devices.

According to another aspect of the invention there is provided a method for simultaneously communicating with multiple smart card devices during production, said method comprising:

mounting said devices on a common platform so that each device has a respective chip coupled to a respective communication interface;

positioning said common platform on a support surface of a multi-head reader so that the respective communication interface of each device is aligned with a respective head of the reader; and

simultaneously energizing multiple heads of the reader so as to effect communication with respective devices.

According to yet another aspect of the invention there is provided a reader for communicating simultaneously with multiple smart card devices formed on a common platform so that each device has a respective chip coupled to a respective communication interface, said reader comprising:

a support surface for placing the common platform thereon, a plurality of spaced apart reading heads fixedly supported relative to said support surface each for communicating with a respective communication interface of one of the devices on said common platform, and

a communication port coupled to the plurality of reading heads for coupling to a controller that is configured to energize selected reading heads simultaneously so as to effect communication with the respective device.

According to a still further aspect of the invention there is provided a system for communicating simultaneously with multiple smart card devices formed on a common platform so that each device has a respective chip coupled to a respective communication interface, said system comprising:

a reader comprising:
a support surface for placing the common platform thereon,
a plurality of spaced apart reading heads fixedly supported relative to said support surface each for communicating with a respective communication interface of one of the devices on said common platform, and
a communication port coupled to the plurality of reading heads; and

a controller coupled to the communication port and configured to energize selected reading heads of the reader simultaneously so as to effect communication with the respective device.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a pictorial representation of an inlay test system according to the invention;

FIG. 2 is a pictorial representation of an inlay sheet supporting multiple inlays according to an embodiment of the invention for testing by the inlay tester shown in FIG. 1;

FIG. 3 is a schematic representation of the inlay test system shown in FIG. 1 showing a detail of an inlay tester;

FIG. 4 is a schematic representation of a software component for use by the inlay test system shown in FIG. 1;

FIG. 5 is a flow diagram showing principal operations carried out by a computer coupled to the inlay tester for relaying operations to readers thereof;

FIG. 6 is a flow diagram showing operations carried out by a single thread generated by the computer during communication with a specific reading head of the inlay tester;

FIG. 7 is a schematic timing diagram showing simultaneous operation of multiple threads each executed by a respective reading head of the inlay tester; and

FIG. 8 is a pictorial representation of an inlay sheet supporting multiple inlays according to a different embodiment of the invention.

### DETAILED DESCRIPTION OF EMBODIMENTS

In the description, components that are common to, or serve a common function in, different embodiments will be referenced by identical reference numerals.

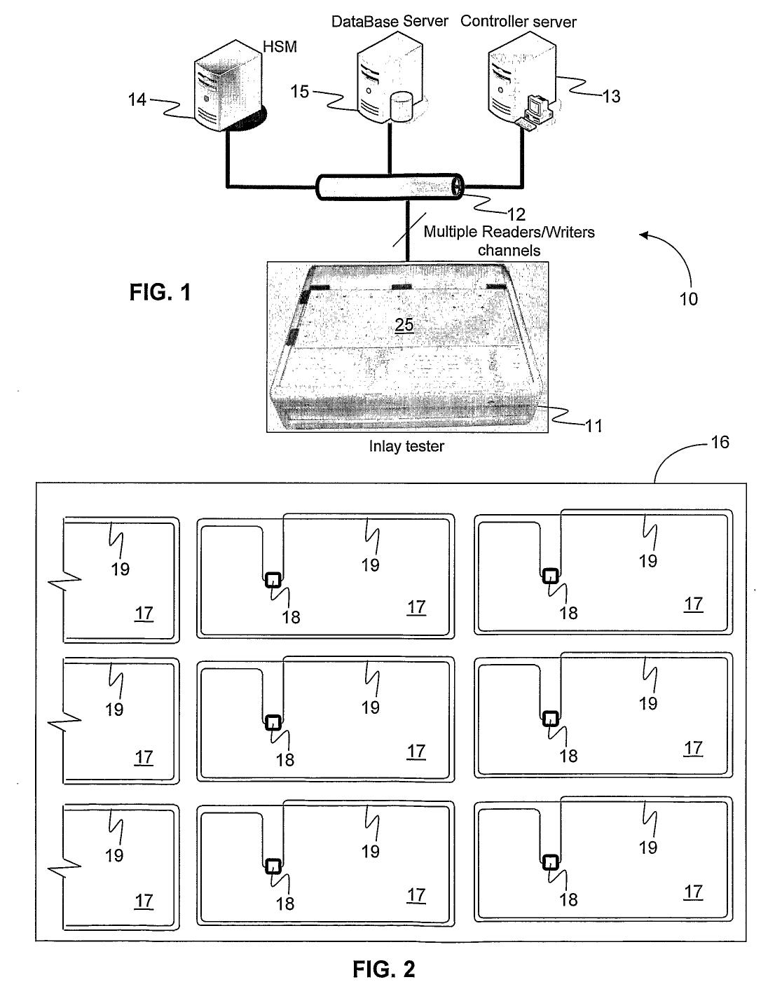

FIG. 1 is a pictorial representation of an inlay test system 10 comprising an inlay tester 11 (constituting a reader) connected via a communication channel 12 such as USB or Ethernet (TCP/IP) to a controller server 13, a hardware security module (HSM) 14 and a database 15. The controller server is typically a suitably programmed PC and will therefore be referred to in the following description simply as ‘computer’.

FIG. 2 is a pictorial representation of an inlay sheet 16 supporting multiple inlays 17 for testing by the inlay tester 11 shown in FIG. 1. Each inlay 17 is shown schematically as an IC chip 18 coupled to a coil antenna 19, typically formed by printing or etching on an insulating sheet constituting the inlay sheet 16. The method of manufacture of the inlays is known in the art and is not itself a feature of the invention, which is principally directed to an effective way to test and/or customize all the inlays prior to separation of the discrete inlays 17 from the inlay sheet 16.

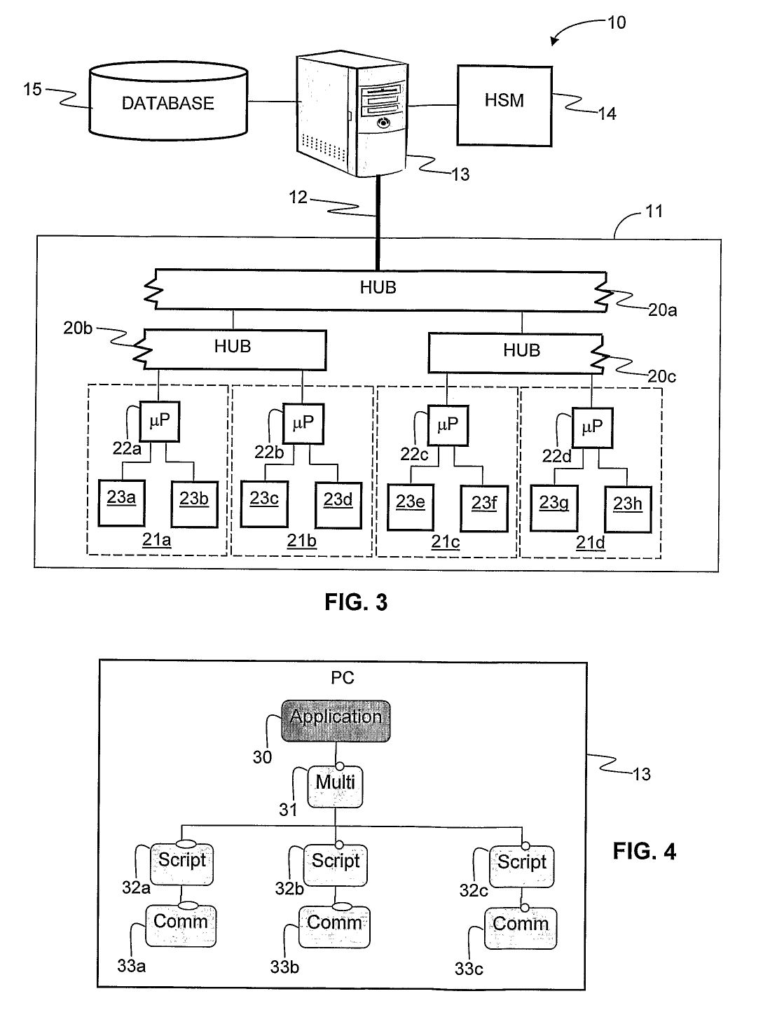

FIG. 3 is a schematic representation of the inlay test system 10 shown in FIG. 1 showing a detail of an inlay tester 11. Thus, it is seen that the inlay tester 11 comprises a hub 20a that is coupled to the communication channel 12 is known manner. Coupled to the hub 20a are a plurality of hubs, of which two are shown in the figure denoted as 20b and 20c, and to each of which a plurality of readers 21 are connected. Thus, by way of non-limiting example only, the figure shows two readers 21a and 21b coupled to the hub 20b and two readers 21c and 21d coupled to the hub 20c. However, it is to be understood that in practice more readers may be coupled to each hub, the only limitation being the number of ports in the hub. Likewise, even when all ports of a hub are occupied, multiple hubs can be cascaded in known manner as shown in the figure.

Each reader 21 comprises a microprocessor denoted generally as 22 having one or two output ports to each of which is connected to a respective coil antenna 23. Thus, in accordance with one embodiment, a reader 21a comprises microprocessor 22a connected to a pair of coil antennas 23a, 23b via respective output ports; a reader 21b comprises microprocessor 22a connected to a pair of coil antennas 23c, 23d via respective output ports; and so on. Each of the coil antennas 23 forms part of a respective reading head that is fixedly supported relative to a support surface 25 of the inlay tester 11 (shown in FIG. 1) so as to be in proper spatial alignment with a respective coil antenna 19 of one of the inlays 17 on the inlay sheet 16. By such means, when the inlay sheet 16 is correctly positioned on the support surface 25, the respective coil antenna 19 of each inlay 17 will be sufficiently aligned with a corresponding coil antenna 23 to allow mutual contactless communication between the inlay 17 and the reader 21 when the corresponding coil antenna 23 is energized.

Obviously, in order to minimize wastage and thereby render the production process more economical, the inlays 16 should be packed as densely as possible. However, in the case where the inlays are provided with contactless communication interfaces as described above, there is an increased likelihood of crosstalk whereby a reader coil antenna may be sufficiently close to multiple inlay coil antennas so as to communicate with more than one inlay. This, of course, must be avoided. One way to avoid the risk of crosstalk is simply to space the mutually adjacent inlays sufficiently far from each other that each reader coil antenna is able to effect contactless communication with only one inlay. But in practice this is wasteful of material since more space in the inlay sheet 16 must be left vacant. An alternative approach is to provide each reader with multiple coil antennas, each in respect of a single designated inlay and to energize the reader coil antennas at alternating times so that adjacent inlays are addressed in a staggered relationship and are never addressed at the same time. By such means, the mutual spacing between inlays can be optimized along both their widths and heights so as to remove any possibility of crosstalk while maximizing the number of inlays that can be accommodated on each inlay sheet. This may require that the spacing between adjacent columns of inlays be different than that between adjacent rows thereof, depending on how many reader coil antennas can be independently addressed by each reader, this being determined by the number of output ports in the microprocessor. Of course, yet another approach is to provide one reader coil antenna for each reader and then to operate the readers in staggered relationship, but this is wasteful of readers since not all are employed at the same time. By configuring each reader to address only a designated one of multiple coil antennas coupled to separate output ports thereof, two advantages are thus achieved. First, there is no risk that a reader will be able to address multiple coil antennas and thereby communicate with two or more inlays simultaneously. Secondly, since each reader serves multiple inlays, fewer readers are required and the cost is thereby reduced.

FIG. 4 is a schematic representation of a software component for use by the inlay test system shown in FIG. 1. The computer 13 runs an application 30 that requires specific data to be written to the respective IC chips 18 of each of the inlays 17. For example, in the case that the inlays 17 are intended for use as credit cards, the application may read the card ID and convey it to the HSM 14 where it is digitally signed using a key that is unique for the current card. The digitally signed card ID is then securely conveyed to the application where it is encapsulated in the script for the appropriate inlay and written to the chip in a secure manner. During use of the card, the digital signature serves to authenticate the card as authorized by the credit card company. It will be understood that this procedure is provided by way of non-limiting example only, and any other secure data that is unique to a given card and serves to authenticate the card may be conveyed from the HSM 14 to the application for storing in the inlay chip. As noted above, the unique data/key is issued by the credit card company and must not only be completely secure, but must also be conveyed to the chip is a highly secure manner that precludes any possibility of eavesdropping and thus being able to ascertain the unique data/key by an external party. This requirement is met by the application 30 including a multi-threaded dispatcher module 31 that opens multiple threads that are mutually separate and independent, so that each thread may exchange data from the HSM. Having done so, each thread compiles a corresponding script 32a, 32b, 32c . . . , so that each script contains different data, opens a secure communication channel 33a, 33b, 33c . . . , with a designated reading head e.g. a coil antenna 23, and then executes the script in respect of the designated coil antenna 23.

It should be understood in this context that the unique data/key read from the HSM 14 is used by the credit card company to identify the credit card as bona fide and is not the same as the manufacturer's data/key that, as noted above, is stamped to the card memory during manufacture. The manufacturer's data/Key is not secure and is therefore not amenable for use as a secure credit card. In contrast, the credit card data/key is securely generated in the HSM 14 and is read via a completely secure communication channel that prevents eavesdropping and is likewise written to a designated card in an equally secure manner. In practice, the credit card unique data/key may be generated from the manufacturer's data/key using a digital signature algorithm based on a private key stored in the HSM or by a diversified key algorithm, so that only signed cards are maintained in the database of the credit card company. Thus, even if a hacker were to obtain or forge inlay sheets bearing the manufacturer's data/keys, without access to the HSM he would be unable to sign the cards and therefore the forged cards would not be usable as credit cards.

In saying this, it is to be understood that the exact manner in which cards are rendered secure is not itself a feature of the invention other than to remark that secure interaction between a card of known manufacturer's data/key and the HSM is required. The invention achieves this requirement by means of software that creates a secure communication object between the controller and a designated inlay and runs a custom script that is formatted by the controller for each inlay. The script typically includes data that is read from the HSM for the designated inlay and, to this end, the controller feeds the manufacturer's data/key of the designated inlay to the HSM using a secure communication channel and receives from the HSM via a communication channel data that is encapsulated as part of the script and used to write secure data to the inlay chip. As noted, the data may be a digital signature or any other secure data that enables the credit card company to identify the card as genuine.

The software has the following main features:
Communications with multiple devices.
Parallel execution.
“Develop on one—run on many”.
The user is isolated from the details of communications and multiplicity.

The software comprises the following modules:
Comm: handles communications with the device. Contains methods like SendData( ), ReceiveData( ).
Script: handles the logic. Uses the Communications object to implement the specific logic required. Has a reference to a communications object. Logic is implemented in the Run( ) method which abstract. Specific implementations are implemented in derived classes. Run( ) method is run in a dedicated thread by the Multi object.
Multi: has the following methods:
   detect all connected devices and create a Comm object for each one.
   Receives a path to a script containing a class derived from Script class. Instantiates such class for each Comm object and associates the Comm object to the Script Derived Object.
   calls the Run( ) method of Script derived object.

The communication with the HSM 14 and/or the database 15 is done by the script module.

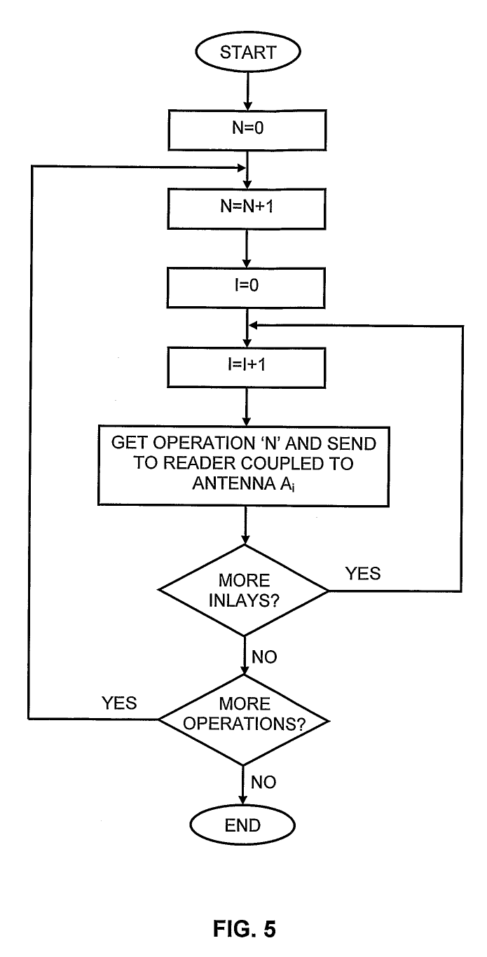

FIG. 5 is a flow diagram showing the principal operations carried out by the computer 13 for relaying operations to readers 21 of the inlay tester 11. In FIG. 5, the variable “N” is an index to one of multiple operations or processes to be executed in respect of each inlay indexed by the variable “I”. Thus, for each inlay sheet 16, “N” is initialized to zero and incremented by 1. The same is done for “I” so that initially the application gets the first operation for the first inlay and sends it to the appropriate reader. To this end, the application may access a look-up table that maps each inlay to a corresponding reader. The inlay tester 11 shown by way of example in FIG. 3 has two reading heads (i.e. coil antennas 23) coupled to each reader 21 for the reasons that were explained previously, but in general as many reading heads may be coupled to each microprocessor 22, as there are output ports in the microprocessor 22. Thus, in the case where a reader is adapted to address multiple reading heads, the script must identify the reader and must also inform the reader which reading head to activate, i.e. which coil antenna to energize in the case of contactless communication. In the case where each reader has only a single reading head, the reader 21 maps to a single inlay and the script therefore need only identify the reader. This process is repeated for each inlay so that multiple parallel operations are initiated for all inlays substantially simultaneously. This is done repeatedly for each operation until all operations are completed.

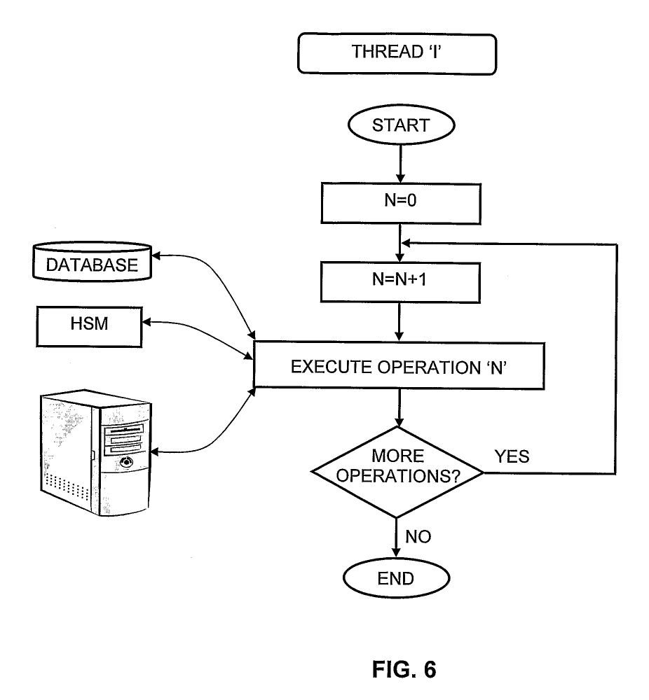

FIG. 6 is a flow diagram summarizing operations carried out by a single thread generated by the computer during communication with a specific reading head of the inlay tester. Essentially, each thread communicates with the respective microprocessor 22 in the addressed reader 21. The microprocessor 22 receives the desired command/script running in the computer 13, possibly containing secure data obtained directly from the HSM 14 and/or the database 15. The microprocessor 22 then executes the command/script and repeats for all operations shown in the figure.

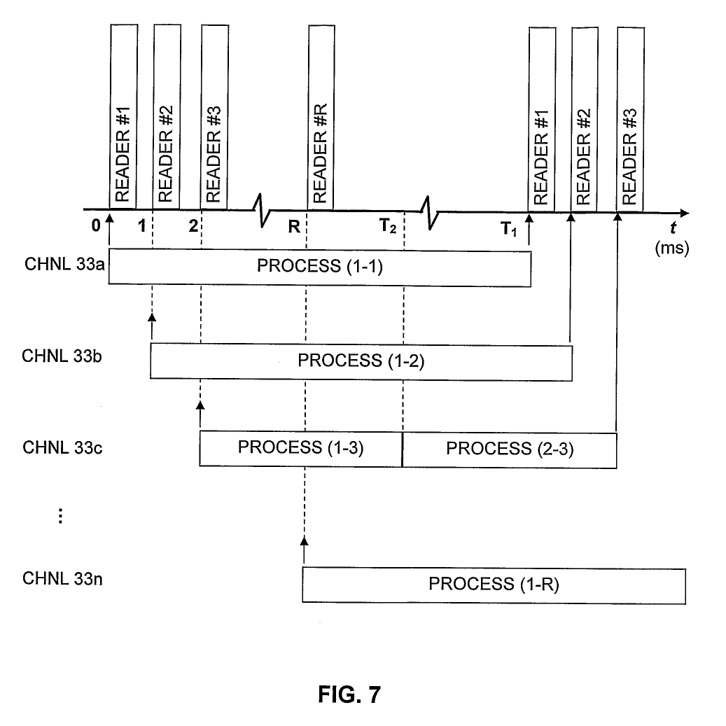

FIG. 7 is a schematic timing diagram showing simultaneous operation of multiple threads each executed by a respective reader of the inlay tester. Thus, it is seen that multiple independent channels 33a, 33b . . . 33n are established for each reader, so as to allow the reader to execute a process defined by the script. Each process is initiated by the application, so as to create a respective thread which then runs independent of other threads. So, for example, the first process (or thread) for the first reading head shown as (1-1) commences at time 0 and each subsequent thread commences at regular time intervals of 1 ms. The process (1-1) takes T₁ milliseconds after which the second process (2-1) would commence for the first reading head. It is assumed that T₁ is so much longer than 1, that during the time that it takes for the process (1-1) to complete, all other parallel processes for the remaining channels commence and run independent of each other. In the particular example shown in the figure, the first process for the second reading head shown as (1-2) commences at time 1 and also takes T₁ milliseconds, so that the second reading head commences its second process 1 ms after the first reading head. But generally, the parallel processes will have different durations. For example, the first process for the third reading head shown as (1-3) commences at time 2 and takes only T₂ milliseconds (T₂<T₁), so that the third reading head commences its second process (2-3) before either of the processes (1-1) or (1-2) has terminated.

It will be appreciated that while the inlay sheet 16 has been described with particular regard to inlays having a contactless communication interface, the IC chips 18 may be coupled instead or additionally to a contact field and the readers 21 may likewise be provided with reading heads having contacts for engaging contact fields of the corresponding inlays.

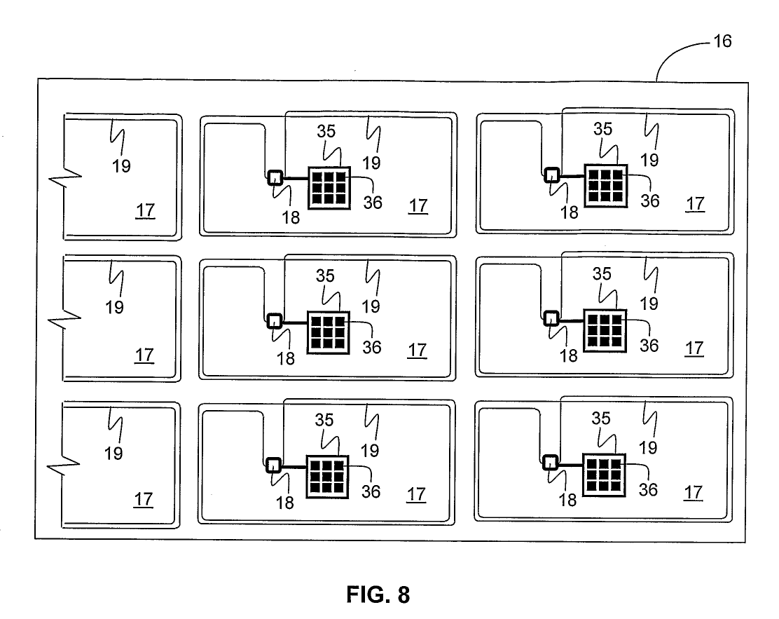

FIG. 8 is a pictorial representation of an inlay sheet 16 supporting multiple inlays 17 according to such an embodiment wherein each inlay 17 includes a contact field 35 having contacts 36 that may conform to the ISO 7816 standard to allow contact communication with a corresponding contact field in the reader. Although in the figure each inlay 17 is shown as having both a contactless interface constituted by the coil antenna 18 as well as a contact interface constituted by the contact field 35, it will be understood that this is by way of example only. The principles of the invention are equally applicable for smart card devices having only one or both types of communication interface.

It will also be appreciated that since the invention allows for testing multiple inlays during manufacture by testing in situ while the inlays are mass-produced on a common inlay sheet, any inlay found to be defective can be fixed prior to lamination of the complete inlay sheet. For example, faulty connections can be repaired or defective chips can be replaced. Obviously this applies also where no special customization is required. Once testing and customization, if required, are complete, the inlay sheet is laminated and the laminate inlay sheet is then cut to separate the cards.

It will also be understood that while the invention has been described with particular regard to simultaneous testing and customizing of inlays, the principles of the invention are equally applicable to testing and customizing of finished articles containing an IC chip and a smart card interface. For example, IL 179187 corresponding to PCT/IL2006/001452 and entitled “Fob having a clip and method for manufacture thereof” filed Dec. 18, 2006 in the name of the present applicant, describes in one embodiment a key fob containing a PCB having a contactless smart card mounted thereon. After manufacture, such key fobs are typically transported in a molded plastic tray rather like chocolates are often presented in selection boxes. The tray thus contains multiple smart card devices each having a respective contactless interface that may be addressed by a respective reading head of the inlay tester. Such a tray is thus analogous to the inlay sheet 16 and the individual smart card devices mounted therein are analogous to the inlays 17 as described above with reference to FIG. 2. Therefore, within the context of the invention and the appended claims, the term “device” refers to a smart card inlay in its normal usage as well to any smart card device that is mounted on a common platform and is capable of communicating with a reading head in the inlay tester. Likewise, the term “common platform” refers both to a sheet of material supporting multiple IC chips and respective communication interfaces that are an integral and inseparable part of the inlay sheet and which is subsequently cut to produce discrete smart card inlays that may then be laminated; as well as to any other mount or the like used to support smart card devices, which are not part of the common platform and are subsequently removed therefrom.

It has already been noted that the controller 13 according to the invention is typically a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1-44. (canceled)

45. A method of substantially simultaneously communicating with multiple smart card devices supported on a common platform so that each said smart card device has a respective chip coupled to a respective device antenna, said method comprising:
positioning said platform relative to a multi-head reader having a plurality of reader antennas so that the respective device antenna of each said smart card device is sufficiently aligned with a respective said reader antenna to allow mutual contactless communication with said respective smart card device via said respective device antenna when said respective reader antenna being energized; and
substantially simultaneously energizing said plurality of reader antennas so as to effect each said mutual contactless communication.

46. The method according to claim 45, wherein said substantially simultaneously energizing comprises separately customizing at least one of said smart card devices.

47. The method according to claim 45, wherein each said mutual contactless communication is established according to a unique key of a respective said smart card device.

48. The method according to claim 45, further comprising:
substantially simultaneously energizing selected non mutually adjacent reader antennas.

49. The method according to claim 45, further comprising energizing only reader antennas that are diagonally proximate.

50. The method according to claim 45, further comprising at least one of reading data stored in a respective chip of selected smart card devices and writing data to a respective chip of selected smart card devices.

51. The method according to claim 45, wherein writing data to a respective chip of selected smart card inlays comprises:
reading data from a secure unit;
opening a secure communication channel between the reader and the chip of the smart card device; and
writing said data to the chip of the smart card device using said secure communication channel.

52. The method according to claim 45, wherein the common platform comprising an inlay sheet supporting multiple smart card devices.

53. The method according to claim 45, further comprising providing each said smart card device as a part of a finished article, said common platform comprising a plurality of mounts each for supporting a respective said finished article.

54. The method according to claim 53, further comprising providing said common platform as a molded tray having multiple recesses each for accommodating therein a respective said finished article.

55. The method according to claim 45, wherein said common platform is positioned on a support surface of the multi-head reader.

56. A reader configured to communicate substantially simultaneously with multiple smart card devices formed in known spatial relationship on a common platform so that each smart card device has a respective chip coupled to a respective device antenna, said reader comprising:
a plurality of spaced apart reader antennas spatially disposed to allow mutual contactless communication with a respective said smart card device via each said reader antenna and a corresponding said device antenna of said respective smart card when the respective reader antenna being energized; and
a communication port coupled to the plurality of reader antennas for coupling to a controller that is configured to energize a selected group of said plurality of reader antennas substantially simultaneously so as to effect said mutual contactless communication.

57. The reader of claim 56, wherein said selected group comprising non mutually adjacent reader antennas.

58. The reader of claim 56, wherein said communication port is at least one of a universal serial bus (USB) compatible and a transmission control protocol/internet protocol (TCP/IP) compatible.

59. The reader of claim 56, further comprising a support surface for placing the common platform thereon.

60. The reader of claim 59, wherein said plurality of reader antennas are fixedly supported relative to the support surface.

61. A system configured to enable communicating substantially simultaneously with multiple smart card devices formed in known spatial relationship on a common platform so that each device has a respective chip coupled to a respective device antenna, said system comprising:
a reader comprising:
a plurality of spaced apart reader antennas spatially disposed to allow mutual contactless communication with a respective said smart card device via each said reader antenna and a corresponding said device antenna of said respective smart card device when the respective reader antenna being energized; and
a communication port coupled to the plurality of reader antennas for coupling to a controller that is configured to energize a selected group of said plurality of reader antennas substantially simultaneously so as to effect said mutual contactless communication.

62. The system of claim 61, wherein said reader comprising a plurality of reading heads each comprises a group of said plurality of reader antennas, said controller being adapted to energize only one reader antenna in each said reading head at any given time.

63. The system of claim 61, wherein said plurality of reader antennas are fixedly supported relative to the support surface.

64. The system according to claim 63, wherein said reader comprising a plurality of reading heads each comprises a pair of said plurality of reader antennas, each reader antenna of said pair being supported relative to said support surface so as to be diagonally proximate.

65. The system of claim 61, wherein the controller is adapted to run a plurality of independent program threads so as to permit substantially simultaneous mutually independent and disassociated communications between respective reading heads and smart card devices.

66. The system of claim 65, wherein the program threads are instances of a communication object.

67. The system of claim 61, wherein the controller comprises a multi-threaded dispatcher module that is coupled to a hardware security module and is responsive to multiple unique chip IDs (Identifications) received therefrom for creating and running a respective communication object and script.
